(19) United States
(12) Patent Application Publication
(10) Pub. No.: US 2003/0112466 A1
(43) Pub. Date: Jun. 19, 2003

(54) Duplex pharmacy label and method

(76) Inventor: Ricci J. Leonardi, Gurnee, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/022,583

(22) Filed: Dec. 17, 2001

(51) Int. Cl. G06K 1/00; G06F 15/00

(52) U.S. Cl. 358/1.18

(57) ABSTRACT

A system for supplying duplex pharmacy labels comprises a sheet, a printer arranged to print on both sides of the sheet, a database, and a controller. The sheet includes an obverse face and a reverse face, the obverse face of the sheet including a first area and a second area, the first area of the obverse face including a pair of peel-off labels removably disposed on a backing surface. The reverse face of the sheet includes a first area opposite the first area of the first side, with at least a portion of the first area of the reverse face formed by a reverse face of the backing surface. The controller forwards patient-specific data for a selected patient and medication-specific data for a selected medication to the printer, thereby causing the printer to print on the obverse face and the reverse face.

### FIELD OF THE INVENTION

The present invention relates generally to pharmacy labels and, more specifically, to a pharmacy label that incorporates, for example, prescription drug information, store and customer receipt information, and other pertinent data, onto both sides of a single printed sheet having peel-off portions, and to a system for creating such a pharmacy label.

### BACKGROUND OF THE INVENTION

Pharmacy labels for prescription medications are generally well known in the art. Typically, a pharmacy label will include, for example, the name of the prescription drug along with information concerning the recommended dosage, usage instructions, drug interaction information, and perhaps other precautionary information such as generalized warnings. The name of the prescribing physician is typically included, along with the patient's name and address. At least a portion of the label may also function as a receipt. As a further option, the label may also include vendor advertising.

Many pharmacy labels are computer generated from a blank or partially preprinted business form that is fed into a printer. On many labels, a portion of the pre-printed sheet will form a peel off label that may be printed, detached from the sheet, and attached to a vial. Thus, the printer and the sheet must be properly adapted to apply printing to the peel off portion of the sheet. Often, this requirement leaves a portion of the sheet blank. Because the typical pharmacy label must include a wide variety of information, space on the sheet is at a premium. Thus, there is a continuing need to maximize the usage of space on the sheet in order to convey a maximum amount of information.

### BRIEF DESCRIPTION OF THE DRAWINGS

FIG. 1 is a plan view illustrating the obverse face of a duplex pharmacy label in accordance with the present invention;

FIG. 2 is a plan view of the reverse face of the duplex pharmacy label of FIG. 1;

FIG. 3 is a perspective view of the duplex pharmacy label of FIGS. 1 and 2 and illustrating the device in a partially folded state;

FIG. 4 is a plan view of the duplex pharmacy label in at least one possible folded state; and

FIG. 5 is a schematic diagram of the system for creating the pharmacy label of FIGS. 1 and 2.

### DETAILED DESCRIPTION OF THE PREFERRED EMBODIMENT

The example described herein is not intended to be exhaustive or to limit the scope of the invention to the precise form or forms disclosed. Rather, the following exemplary embodiment has been chosen and described in order to best explain the principles of the invention and to enable others skilled in the art to follow the teachings thereof.

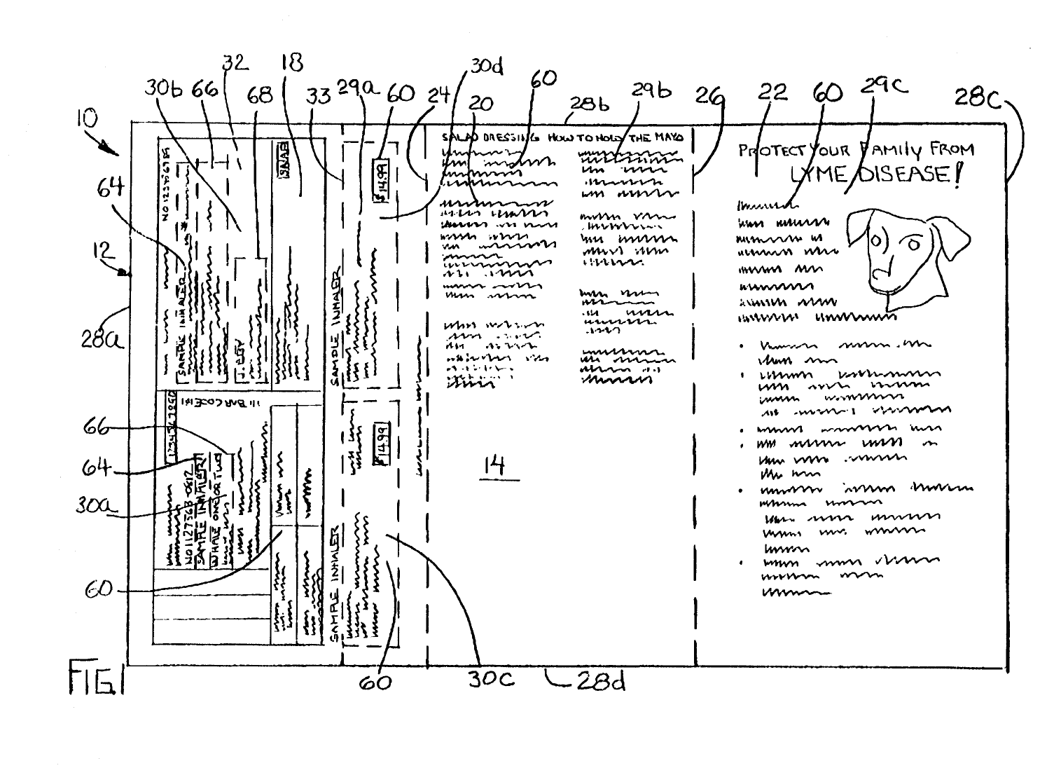

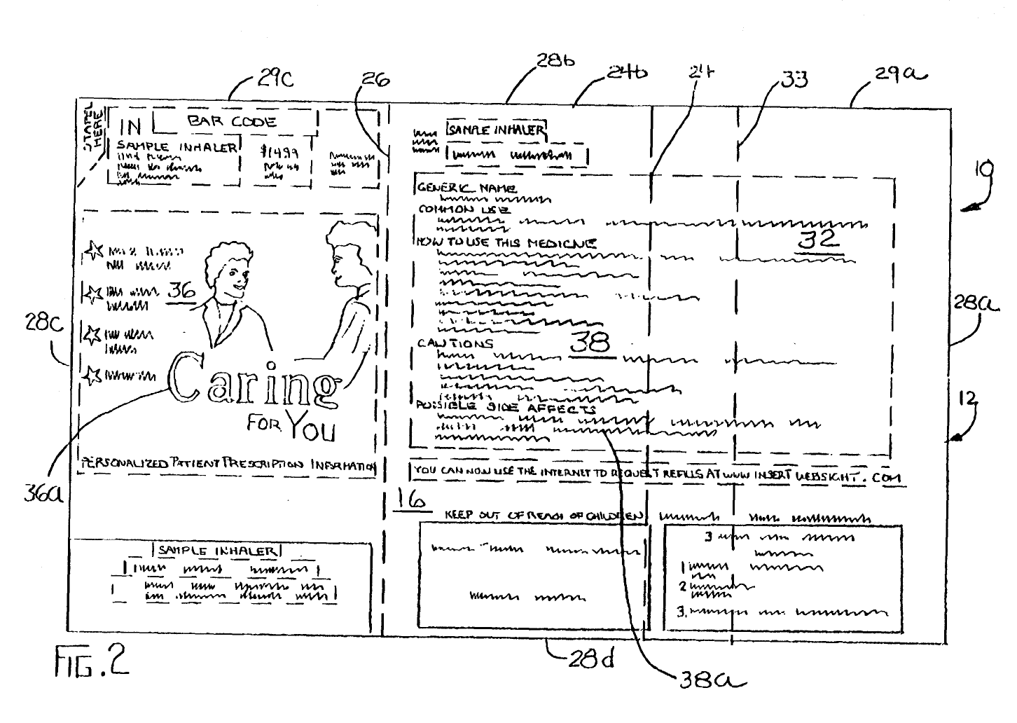

Referring now to the drawings, FIGS. 1 and 2 show a duplex pharmacy label referred to by the reference numeral 10 and which is assembled in accordance with the teachings of the present invention. The label 10 is preferably formed from a sheet 12 of paper or other suitable printable material. Preferably, at least a portion of the sheet 12 may include pre-printed information as will be outlined in greater detail below. The label 10 includes an obverse face 14 (shown in plan view in FIG. 1), and a reverse face 16 (shown in plan view in FIG. 2). As shown in FIG. 1, the obverse face 14 includes a first area 18, a second area 20, and a third area 22. The first area 18 is separated from the second area 20 by a fold line 24 (indicated by dotted lines in FIGS. 1 and 2), while the second area 20 is separated from the third area 22 by a fold line 26 (indicated by dotted lines in FIGS. 1 and 2).

The label 10 is generally bounded by a plurality of edges 28a through 28d, with the fold lines 24, 26 running generally perpendicular to and between the edges 28b and 28d. The fold lines 24, 26 divide the label 10 into three sections 29a, 29b and 29c. The section 29a is bounded by the edges 28a, 28b, 28d, and the fold line 24. Similarly, the section 29b is bounded by the edges 28b, 28d, and the fold lines 24 and 26. Finally, the section 29c is bounded by the edges 28b, 28c and 28d and the fold line 26. In the embodiment shown, the dimensions of the section 29a roughly correspond to the dimensions of the first area 18. On the other hand, the areas 20 and 22 are separated by a border 31 which, in the disclosed example, need not be co-linear with the fold line 24. Thus, the dimensions of the areas 20, 22 need not correspond exactly to the dimensions of the sections 29b and 29c. As an alternative, additional or fewer fold lines (not shown) dividing the label 10 into more or fewer sections (not shown) may be provided as desired.

As shown in FIG. 1, the first area 18 of the obverse face 14 includes a pair of peel-off labels 30a, 30b. The peel-off labels 30a, 30b are removably supported by or otherwise mounted to a backing surface 32 of the type commonly employed in the art, such that one or both of the peel-off labels 30a, 30b are readily removable and attachable to a separate carrier element using a conventional adhesive as would be known in the art. The carrier element may be, by way of example rather than limitation, a conventional medicine vial (not shown), or any other desired surface such as for record keeping purposes. The backing surface 32 may extend at least partially across the first area 18, such as to a line 33 (indicated by dotted lines in FIGS. 1 and 2) extending between the edges 28b and 28d.

Referring still to the obverse face 14 of FIG. 1, the first area 18, including the peel-off labels 30a, 30b, are printed with various indicia as will be discussed in greater detail below. It will be noted in FIG. 1 that, in the disclosed example, at least a major portion of indicia 18a on the first area 18 may be printed in portrait format. The second area 20 and the third area 22 also are printed with various indicia 20a, 22a, respectively, as will be discussed in greater detail below. It will be noted in FIG. 2 that, in the disclosed example, at least a major portion of the indicia 20a, 22a, on the second and third areas 20, 22 are printed in landscape format. Additional peel-off labels may be provided, such as peel-off labels 30c and 30d, which are bounded in the disclosed example by the line 33 and the dotted lines circumscribing the labels 30c, 30d. In the disclosed example, the labels 30c, 30d may function as receipts, for example. A suitable backing under the labels 30c, 30d may be provided as required.

Referring now to the reverse face 16 shown in FIG. 2, it will be appreciated that the label 10 has been rotated about an axis oriented generally parallel to the fold lines 24 and 26. The sections 29a-29c are visible, with the sections 29a and 29b divided by the fold line 24, and the sections 29b and 29c divided by the fold line 26. A reverse face of the backing surface 32 may be visible, with the reverse face of the backing surface 32 bounded generally by the edges 28a, 28b, 28d, and the line 33. In the example shown, the reverse face 16 includes two areas 36, 38 separated by the fold line 26. It will be noted that in the disclosed embodiment the area 36 extends across both of the sections 29a and 29b, with no dividing border, such that the indicia 36a imprinted on the area 36 in landscape format covers at least a portion of both of the sections 29a, 29b. Alternatively, one or more borders (not shown) may be provided in order to divide the area 36 into further sections as desired. The area 38 includes indicia 38a which in the disclosed example is oriented in landscape format.

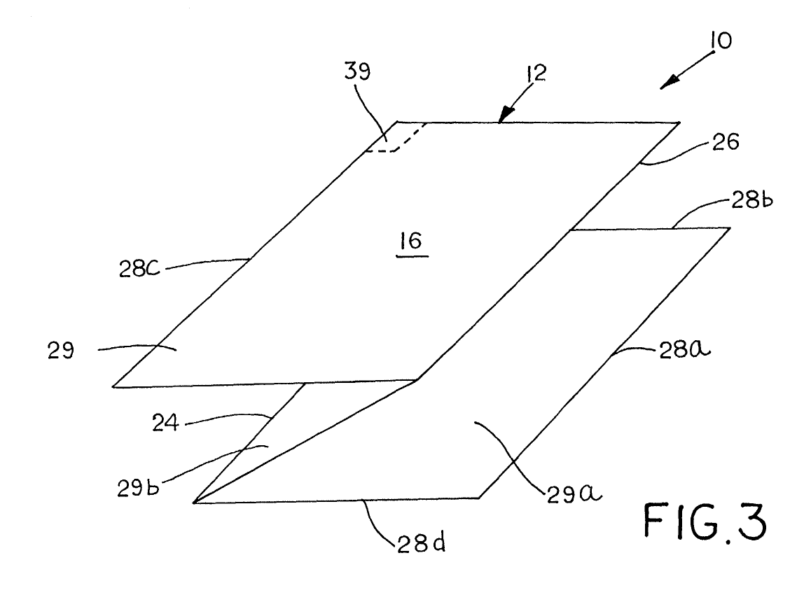

Referring now to FIG. 3, the label 10 is shown in at least one partially folded state, with the sections 29a, 29b and 29c folded along the fold lines 24 and 26. When partially folded as shown, only portions of the reverse face 16 are visible, with the indicia 36a on the area 36 being visible, along with a portion of the indicia 38a of the area 38. Other portions of the indicia 38a are substantially obscured.

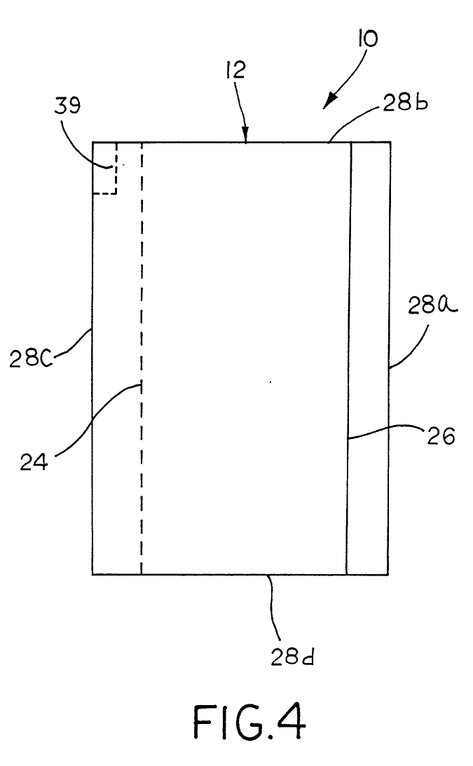

Referring now to FIG. 4, the label 10 is shown in at least one possible fully folded position. It will be noted that when the label 10 is folded as shown, the edge 28c extends outwardly (e.g., to the left of FIG. 4) past the fold line 26. An area 39, which in the disclosed example is in the upper left corner of the section 29c of the label 10, may be reserved to receive an attachment mechanism, such as a staple or other suitable fastener, to permit the label 10 to be suitably secured to a carrier element, such as a prescription bag (not shown).

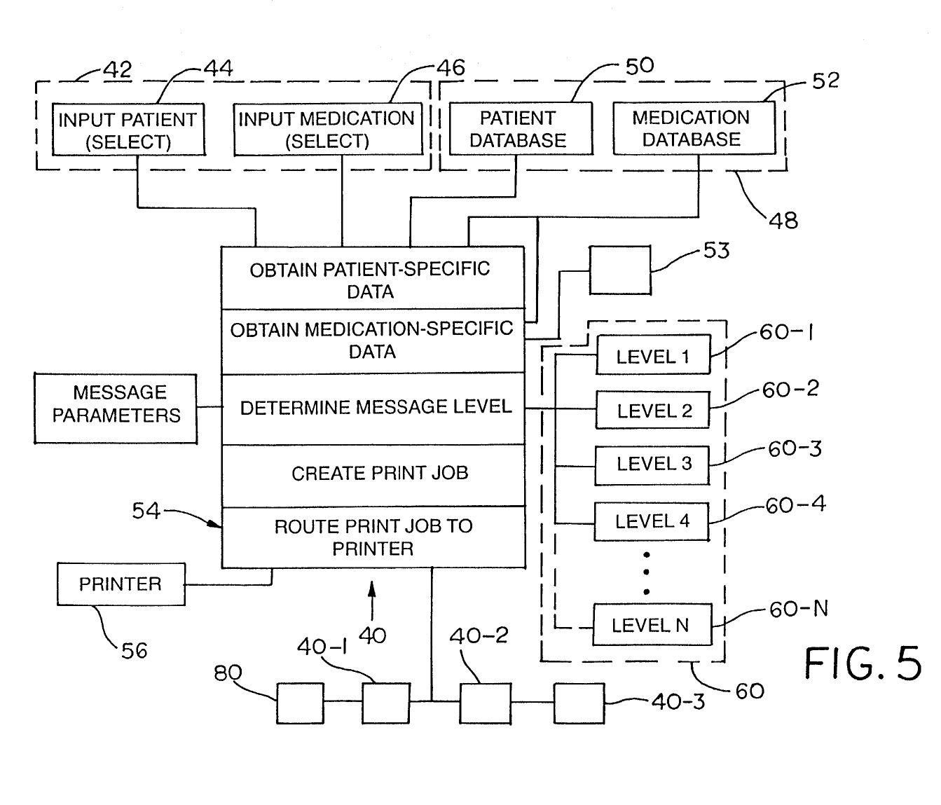

Referring now to FIG. 5, a system 40 for creating the above-described label 10 is shown. The system 40 includes a user interface 42 including a patient input 44 and a medication input 46. The system 40 also includes a database 48 including a patient database 50 and a medication database 52. A physician database 53 may also be provided. The system 40 also includes a controller 54, and a printer 56. A memory 58 stores a number of messages 60 which may be segregated by different levels 60-1, 60-2, 60-3, 60-4, . . . 60-N. The system 40 also has access to message parameters 62 for use in choosing the appropriate message level as will be discussed in greater detail below. At least one of the message levels 60-1, 60-2, 60-3, 60-4, . . . 60-N may be a default message.

Referring again to FIG. 1, the indicia shown thereon may include, by way of example rather than limitation, patient-specific data 64, medication-specific data 66, physician-specific data 68. Further, the indicia may be representative of one or more of at least N different message categories or levels, corresponding to the message levels 60-1 through 60-N. For example, the message level 60-1 may be a default level message, the message level 60-2 may be a date-specific message level, the message level 60-3 may be a geographic-specific message level, and the message level 60-4 may be a store-specific message level. Other suitable message levels may be contemplated.

It will be appreciated that the sheet 12 that forms the label 10 may be a standardized business form, and may include certain pre-printed indicia as desired, such as the name of a store chain, etc. It will also be appreciated that the label 10 may be formatted in any desirable manner, placing the various messages at any desirable location on the faces 14, 16 of the label 10, subject to preserving at least a portion of the available space on the peel-off labels 30a, 30b for certain medication-specific data and patient specific data as will be outlined below.

Referring to FIG. 2, the indicia 36a and 38a shown thereon also may include one or more of the patient-specific data 64, the medication- specific data 66, and the physician-specific data 68. Further, the indicia 36a and 38a may be representative of one or more of the message levels 60-1 through 60-N. Again, the formatting of the reverse face 16 may take any one of a number of suitable forms dependent upon the desires of the user of the system.

In operation, the label 10 is created by the system 40 as follows. A user (not shown) using the interface 42 inputs or otherwise selects a patient and a medication. Both the patient and the medication may already be stored in the system 40, and in such a case the inputting process is more along the line of selection from information into the databases 50, 52 (and 53). The controller 44 obtains patient-specific data and medication specific-data from the respective databases 50, 52. The controller 44, working within the message parameters 62, then chooses one or more of the message levels 60-1 through 60-N, and creates a print job which is routed to the printer 56. The message parameters may include information on prioritizing the various message levels. The printer 56 then prints, for example, the patient-specific data 64, the medication specific-data 66, the physician-specific data 68, and one or more of the chosen message levels 60-1 through 60-N on the label 10 in the desired format.

By way of further explanation, the label 10 is fully duplexed (e.g., printed on both of the obverse face 14 and the reverse face 16). According to the disclosed embodiment, the sheet 12 may measure approximate 8-½″ by 14″ and, when fully printed will provide a label for a medication vial (one of the peel off labels 30a, 30b), a hard copy of the prescription, and a duplicate receipt. The label 10 will also provide one or more warning labels, clinical prescription information such as dosage information and instructions, and may also include a variety of other messages.

Further, according to the disclosed example, at least one of the message levels 60-1 through 60-N may include, for example a verbal description of the physical characteristic of the medication, a picture of the medication, a bar code for verification scanning and/or point of sales scanning, the appropriate medication vial size, and information concerning where in the store location the selected medication is located. According to the disclosed embodiment, the label 10 and the system 40 eliminate the need for printing multiple sheets and/or multiple receipts when carrying out the prescription filling process, thus helping to improve the efficiency and quality of the process.

The label 10 may be formatted as desired using well known programming and printing principles, and the sheet 12 may include one or more pre-printed messages as mentioned above. These pre-printed messages may be specific to a particular pharmacy chain, specific to a particular geographic location, specific to a particular store location, or specific according to any one of a number of possible parameters. As shown in FIG. 4, the system 40 may be connected to a centralized network or system 80, which controls any one of a number of other similar systems (40-1, 40-2, . . . 40-N). Thus, the system 80 may control the messages being printed by each of the systems 40, 40-1, 40-2, . . . 40-N, and may, subject to easily programmable parameters, route the same or different messages to each of the systems 40, 40-1, . . . 40-N. It will also be noted that in the event the system 80 fails, each of the systems 40, 40-1, . . . 40-N are preferably programmed to print a default message from the available message levels as discussed above. At least one of the message levels 60 discussed above may include certain exemplary information, such as whether the prescription is a new prescription or a re-fill prescription, whether the prescription is to be mailed, delivered, pick-up, or received at a drive-thru window, and whether the source of the prescription was received at the store location via the internet, an automated pre-fill program, by telephone, or through a conventional paper prescription form.

Further, referring to FIG. 3, at least a portion of the printed indicia visible on the section 29c of the reverse face 16 may include teasers or other information indicative of the type of information that is printed on the label 10 and which will become visible upon unfolding the label 10 along the fold lines 24, 26 from the positions of FIGS. 3 and 4 to the position of FIGS. 1 and 2.

By way of further example, the message levels 60-1 through 60-N may be further explained as follows. A default message may be provided that is appropriate to all store locations throughout a store chain. Further, one of the levels may contain a date specific message that varies with the day of the week or the calendar date. Further, the messages may be specific to the state, city, or district in which a particular store is located. Preferably, the system will be programmed such that the messages are prioritized. For example, a specific store level message may override a district level message, or vice-versa. Further, if a user attempts to override an existing higher level message for a given date (e.g., a highly prioritized date-specific message), a warning message will appear on the user interface 42 with instructions on the message that is being over-written. Also, the system 40 may be programmed as desired to purge date-specific messages on a periodic basis, such that out of date messages will not be inadvertently printed on the label 10.

Those skilled in the art will appreciate that, although the teachings of the invention have been illustrated in connection with certain exemplary embodiments, there is no intent to limit the invention to the disclosed example. Instead, the intention of this application is to cover all modifications and embodiments fairly falling within the scope of the appended claims either literally or under the doctrine of equivalents.

What is claimed:

1. A system for supplying duplex pharmacy labels comprising:
a sheet, the sheet having an obverse face and a reverse face, the obverse face of the sheet including a first area and a second area, the first area of the obverse face including a pair of peel-off labels, the reverse face of the sheet including a first area opposite the first area of the first side;
a printer, the printer having an input arranged to receive the sheet, the printer further arranged to print on both faces of the sheet;
a database, the database including patient specific data for a plurality of patients and medication specific data for a plurality of medications; and
a controller, the controller operatively connecting the printer and the database, the controller arranged to forward patient specific data for a selected patient and medication specific data for a selected medication to the printer to thereby cause the printer to print patient specific data for the selected patient and medication specific data for the selected medication on the first area of the obverse face and on the first area of the reverse face.

2. The system of claim 1, including a user interface operatively connected to the controller, the user interface enabling a user to input the selected patient and the selected medication.

3. The system of claim 1, wherein the sheet includes at least one fold line dividing the sheet into a plurality of sections.

4. The system of claim 3, wherein the sheet includes a pair of fold lines dividing the sheet into first, second and third sections.

5. The system of claim 4, wherein the first and second area of the obverse face are disposed on the same section.

6. The system of claim 1, wherein the sheet comprises a standardized form, at least a portion of the form containing pre-printed information, the preprinted information being non-patient specific and non-vendor specific.

7. The system of claim 1, wherein a portion of the pre-printed information is in landscape format.

8. The system of claim 1, wherein the patient specific data and the medication specific data are printed in landscape format on one of the faces and in portrait format on the other of the faces.

9. The system of claim 1, wherein at least a portion of the medication specific data on the reverse face is printed in landscape format and extends across the first area of the reverse face and at least a portion of the second area of the reverse face.

10. The system of claim 1, the database including location-specific data for a plurality of store locations, the controller arranged to forward location-specific data for a selected store location to the printer to thereby cause the printer to print the location-specific data for the selected store location on at least one of the obverse face and the reverse face.

11. The system of claim 1, wherein the database includes a message data, the message data comprising a plurality of messages, the controller arranged to forward a selected message to the printer to thereby cause the printer to print the selected message on at least one of the obverse face and the reverse face.

12. The system of claim 11, wherein the message data comprises a plurality of message levels, the message levels including a default level, a date-specific level, a geographic-specific level, and a store-specific level.

13. A system for supplying duplex pharmacy labels comprising:
a sheet, the sheet having an obverse face and a reverse face, the obverse face of the sheet including a first area and a second area, the first area of the obverse face including a pair of peel-off labels removably disposed on a backing surface, the reverse face of the sheet including a first area opposite the first area of the first side, at least a portion of the first area of the reverse face formed by a reverse face of the backing surface; and
a printer, the printer having an input arranged to receive the sheet, the printer further arranged to print on both faces of the sheet;
a database, the database including patient specific data for a plurality of patients and medication specific data for a plurality of medications; and
a controller, the controller operatively connecting the printer and the database, the controller arranged to forward patient specific data for a selected patient and medication specific data for a selected medication to the printer to thereby cause the printer to print patient specific data for the selected patient and medication specific data for the selected medication on the first area of the obverse face and on the first area of the reverse face.

14. The system of claim 13, including a user interface operatively connected to the controller, the user interface enabling a user to input the selected patient and the selected medication.

15. The system of claim 13, wherein the sheet includes a plurality of fold lines dividing the sheet into a plurality of sections, the first area of the obverse face and the first area of the reverse face disposed on the same section.

16. The system of claim 13, wherein the sheet comprises a standardized form, at least a portion of the form containing pre-printed information, the preprinted information including non-patient specific information and non-vendor specific information.

17. The system of claim 13, wherein the patient-specific data and the medication-specific data are printed in landscape format and in portrait format.

18. The system of claim 13, wherein at least a portion of the medication-specific data on the reverse face extends across the reverse face of the backing surface.

19. The system of claim 13, the database including location-specific data for a plurality of store locations, the controller arranged to location-specific data for a selected store location to the printer to thereby cause the printer to print the location-specific data for the selected store location on at least one of the obverse face and the reverse face.

20. The system of claim 13, wherein the database includes a message data, the message data comprising a plurality of messages, the controller arranged to forward a selected message to the printer to thereby cause the printer to print the selected message on at least one of the obverse face and the reverse face.

21. The system of claim 20, wherein the message data comprises a plurality of message levels, the message levels including a default level, a date-specific level, a geographic-specific level, and a store-specific level.

22. The system of claim 21, wherein the plurality of message levels are prioritized.

23. A method for supplying duplex pharmacy labels comprising:
providing a sheet, the sheet having an obverse face and a reverse face;
dividing the obverse face of the sheet into at least a first area and a second area;
providing a pair of peel-off labels on the first area of the obverse face; providing a first area on the reverse face opposite the first area of the obverse face; and
providing a printer, the printer having an input arranged to receive the sheet, the printer further arranged to print on both faces of the sheet;
providing a database, the database including patient-specific data for a plurality of patients and medication-specific data for a plurality of medications; and
providing a controller, the controller operatively connecting the printer and the database;
selecting a patient from the database;
selecting a medication from the database; and
forwarding patient-specific data for the selected patient and medication-specific data for the selected medication to the printer to thereby cause the printer to print the patient-specific data and the medication-specific data on the first area of the obverse face and on the first area of the reverse face.

24. The method of claim 23, wherein the peel off labels are attached to a backing surface, and wherein at least a portion of the first area of the reverse face formed by a reverse face of the backing surface.

25. The method of claim 23, wherein the database includes location-specific data for a plurality of store locations, and including the steps of selecting a store location and forwarding the location-specific data for the selected store location to the printer, and printing the location-specific data on at least one of the obverse face and the reverse face.

26. The system of claim 23, wherein the database includes a plurality of possible messages, and including the steps of selecting one of the messages and forwarding the selected message to the printer, and printing the selected message on at least one of the obverse face and the reverse face.

27. The system of claim 26, wherein the message data comprises a plurality of message levels, the message levels including a default level, a date-specific level, a geographic-specific level, and a store-specific level, and including the steps of choosing a selected one of the message levels, and printing the selected message level on at least one of the obverse face and the reverse face.
